(19) United States
(12) Patent Application Publication
(10) Pub. No.: US 2006/0017748 A1
(43) Pub. Date: Jan. 26, 2006

(54) Apparatus for displaying cross-sectional image and computer product

(75) Inventor: Akio Ozawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/177,439

(22) Filed: Jul. 11, 2005

(30) Foreign Application Priority Data
Jul. 12, 2004 (JP) 2004-205261

(51) Int. Cl. G09G 5/00

(52) U.S. Cl. 345/654

(57) ABSTRACT

In a cross-sectional image displayed on a display screen, a region of interest is designated by a user. In the designated region of interest, a two-dimensional projected image that three-dimensionally represents the cross-sectional image inside the region of interest is displayed. Particularly, a two-dimensional projected image of a tumor three-dimensionally representing an image of a tumor is displayed. An image representing even a depth of a region that the user desires to locally view and a three-dimensional image positioned in a cross-sectional image can be displayed, thereby allowing a morphological feature of a lesion to be easily grasped.

### CROSS-REFERENCE TO RELATED APPLICATIONS

This application is based upon and claims the benefit of priority from the prior Japanese Patent Application No. 2004-205261, filed on Jul. 12, 2004, the entire contents of which are incorporated herein by reference.

### BACKGROUND OF THE INVENTION

1. Field of the Invention

The present invention relates to an apparatus for displaying a cross-sectional image based on tomography, and computer product.

2. Description of the Related Art

Conventionally, in diagnosis using tomographic images obtained by a tomograph based on a computerized tomography (CT) or a magnetic resonance imaging (MRI), it is important to grasp a three-dimensional structure of a target portion. Therefore, to three-dimensionally display the target portion, three-dimensional display technology, such as a volume rendering, has been applied.

In such a conventional technology, a user such as a medical doctor designates a region of interest in a tomographic image to view a three-dimensional structure of the region. The three-dimensional structure is expressed in a two-dimensional projected image. Moreover, to view the three-dimensional structure from a different angle, a rotation processing is performed on the region in the two-dimensional projected image. Thus, the three-dimensional structure viewed from the different angel can be expressed in the two-dimensional projected image.

Furthermore, as such conventional technology, a three-dimensional image processing has been proposed. In the three-dimensional image processing, a three-dimensional image is obtained by projecting three-dimensional data on a plane. The three-dimensional image is displayed so that three-dimensional positional relationship of a target point and a region of interest surrounding the target point with respect to other regions in the three-dimensional image is displayed from an arbitrary direction (for example, Japanese Patent Application Laid-Open Publication No. H9-81786).

However, in the conventional technology described above, in other display areas, which is an area other than a display area in which the region of interest is displayed, a two-dimensional tomographic image is displayed. Therefore, if the user desires to view a three-dimensional structure of a portion displayed in the other display areas after viewing the three-dimensional structure, it is necessary for the user to designate again a region of interest, which is displayed on the other portion to obtain a two-dimensional projected image expressing the three-dimensional structure. Thus, an operation is troublesome, and it takes a while until a desirable display is obtained.

To diagnose a state of an organ, a state of a lesion, or presence or absence of a lesion, the user often views a three-dimensional structure of a region of interest from various angles. However, in the conventional technology, even when a two-dimensional projected image has been rotated to view the three-dimensional structure form a different angle, in other display areas, a cross-sectional image viewed from an angle same as an original angle of the two-dimensional projected image before rotation is still displayed.

Therefore, a boundary between the two-dimensional projected image and the cross-sectional image is not successive, and it is impossible to understand a direction from which an internal part of a human body is being viewed. This may cause a failure in finding a lesion or grasping an accurate state or a morphological feature of an organ or a lesion. As a result, accuracy in diagnosis can be degraded.

### SUMMARY OF THE INVENTION

It is an object of the present invention to solve at least the above problems in the conventional technology.

An image display apparatus according to one aspect of the present invention includes a display unit that includes a display screen on which a cross-sectional image generated based on a plurality of tomographic images is displayed; a designating unit that designates a first region in the cross-sectional image, the first region being an arbitrary region of interest; and a control unit that controls to display, in the first region, a two-dimensional projected image that three-dimensionally expresses a portion of the cross-sectional image inside the first region.

A computer-readable recording medium according to another aspect of the present invention stores an image display program for displaying a cross-sectional image generated based on a plurality of tomographic images on a display screen. The image display program makes a computer execute designating a first region in the cross-sectional image, the first region being an arbitrary region of interest; and displaying, in the first region, a two-dimensional projected image that three-dimensionally expresses a portion of the cross-sectional image inside the first region.

An image display method according to still another aspect of the present invention is for displaying a cross-sectional image generated based on a plurality of tomographic images on a display screen. The image display method includes designating a first region in the cross-sectional image, the first region being an arbitrary region of interest; and displaying, in the first region, a two-dimensional projected image that three-dimensionally expresses a portion of the cross-sectional image inside the first region.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an image display system according to an embodiment of the present invention;

FIG. 2 is a schematic of a series of tomographic images of a living body obtained by a tomography scanner;

FIG. 3 is a schematic of an image display apparatus according to an embodiment of the present invention;

FIG. 4 is a flowchart of an image display process of the image display apparatus;

FIG. 5 is a flowchart of the image display process;

FIG. 6 is a flowchart of the image display process;

FIG. 7 is a flowchart of the image display process;

FIG. 8 is a schematic for illustrating simplified volume data;

FIG. 9 is a flowchart of a process for calculating a coordinate-system transformation matrix;

FIG. 10 is a schematic of a tomographic image displayed on a display screen;

FIG. 11 is a schematic of a cross-sectional image that includes a two-dimensional projected image displayed in a region of interest;

FIG. 12 is a flowchart of a process for generating rotation parameters;

FIG. 13 is a schematic of an image after a rotation process;

FIG. 14 is a of an image of the region of interest shown in FIG. 13 after a moving process is performed; and

FIG. 15 is a block diagram of the image display apparatus.

### DETAILED DESCRIPTION OF THE PREFERRED EMBODIMENTS

Exemplary embodiments according to the present invention will be explained in detail below with reference to the accompanying drawings.

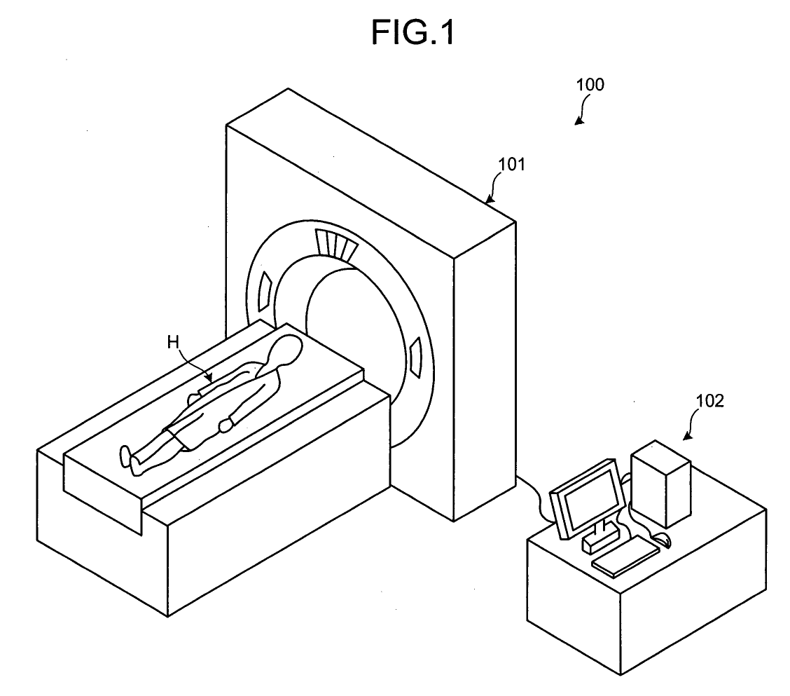

FIG. 1 is a schematic of an image display system 100 according to an embodiment of the present invention. As shown in FIG. 1, the image display system 100 includes a tomography scanner 101 and an image display apparatus 102. The tomography scanner 101 includes a CT scanner or an MRI scanner for obtaining a series of tomographic images of a living body H, such as a living human body.

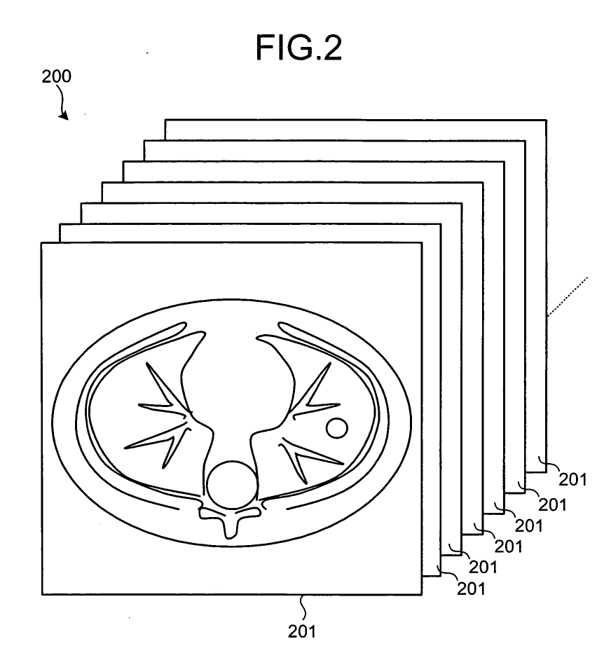

FIG. 2 is a schematic of the series of tomographic images. As shown in FIG. 2, tomographic images 201 are two-dimensional images of, for example, 512 pixels by 512 pixels. For simplification of description, it is assumed that a pixel interval and an interval between successive tomographic images 201, that is, a slice interval, are both 1.0 millimeter (mm). Based on a series of tomographic images 200, volume data that can be used in a volume rendering can be generated.

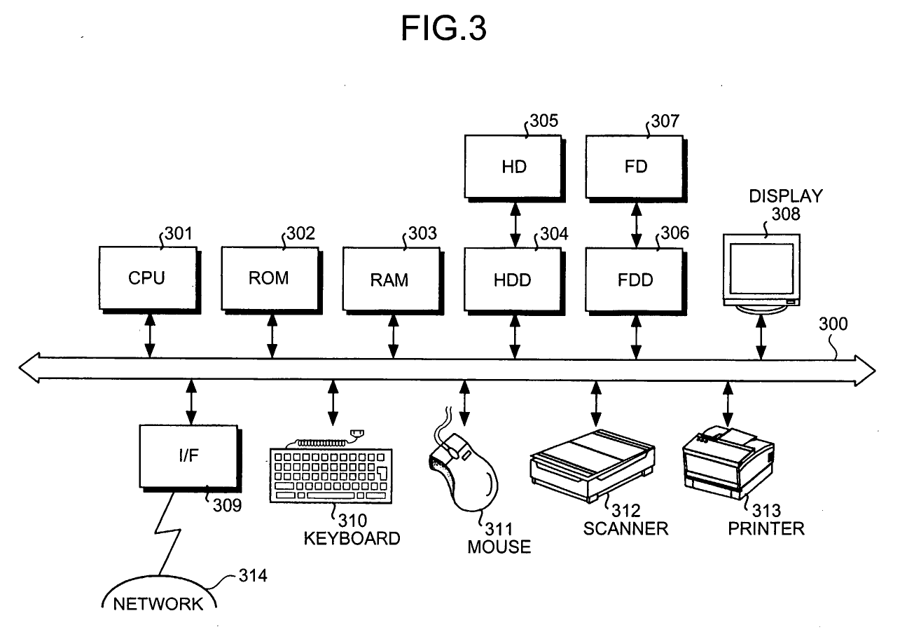

FIG. 3 is a schematic of the image display apparatus 102. As shown in FIG. 3, the image display apparatus 102 includes a central processing unit (CPU) 301, a read-only memory (ROM) 302, a random-access memory (RAM) 303, a hard disk drive (HDD) 304, a hard disk (HD) 305, a flexible disk drive (FDD) 306, a flexible disk (FD) 307, which is one example of a removable recording medium, a display 308, an interface (I/F) 309, a keyboard 310, a mouse 311, a scanner 312, and a printer 313. Each component is connected through a bus 300.

The CPU 301 controls a whole of the image display apparatus 102. The ROM 302 stores a computer program such as a boot program. The RAM 303 is used as a work area of the CPU 301. The HDD 304 controls read/write of data from/to the HD 305 in accordance with the control of the CPU 301. The HD 305 stores data that is written in accordance with the control of the HDD 304.

The FDD 306 controls read/write of data from/to the FD 307 in accordance with the control of the CPU 301. The FD 307 stores data that is written by a control of the FDD 306 and lets the image display apparatus 102 read the data stored in the FD 307.

Apart from the FD 307, a compact disc-read only memory (CD-ROM), a compact disc-readable (CD-R), a compact disc-rewritable (CD-RW), a magnetic optical disc (MO), a digital versatile disc (DVD), and a memory card may also be used as the removable recording medium. The display 308 displays a curser, an icon, a tool box as well as data such as documents, images, and functional information. A cathode ray tube (CRT), a thin film transistor (TFT) liquid crystal display, or a plasma display can be used as the display 308.

The I/F 309 is connected to a network 314 such as the Internet through a communication line and is connected to other devices through the network 314. The I/F 309 controls the network 314 and an internal interface to control input/output of data to/from external devices. A modem or a local area network (LAN) adapter can be used as the I/F 309.

The keyboard 310 includes keys for inputting characters, numbers, and various instructions, and is used to input data. A touch panel input pad or a numerical key pad may also be used as the keyboard 310. The mouse 311 is used to shift the curser, select a range, shift windows, and change sizes of the windows displayed. A track ball or a joy stick may be used as a pointing device if functions similar to those of the mouse 311 are provided.

The scanner 312 optically captures an image and inputs image data to the image display apparatus 102. The scanner 312 may be provided with an optical character read (OCR) function. The printer 313 prints the image data and document data. For example, a laser printer or an inkjet printer may be used as the printer 313.

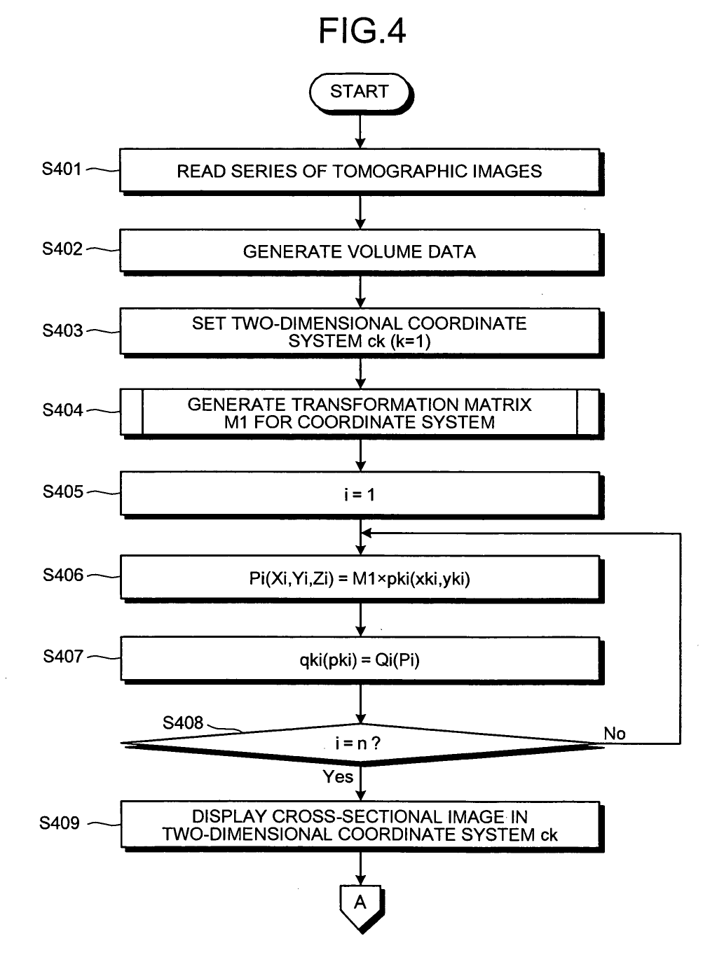

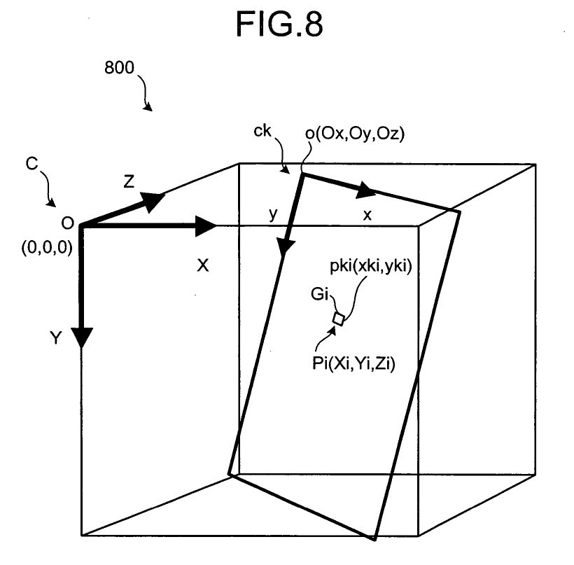

FIGS. 4 to 7 are flowcharts of an image display process by the image display apparatus 102. As shown in FIG. 4, the series of tomographic images 200 shown in FIG. 2 is first read (step S401) to generate volume data (step S402). FIG. 8 is a schematic for illustrating simplified volume data. Volume data 800 is an aggregate of voxels representing a three-dimensional structure of the living body H, and is generated based on the series of tomographic images 200.

The volume data 800 has a three-dimensional coordinate system C. An X axis represents a width (lateral direction) of the tomographic images, a Y axis represents a height (vertical direction) of the tomographic images, and a Z axis represents a direction in which the tomographic images are successively present (a depth direction).

Then, as shown in FIG. 4, a two-dimensional coordinate system ck representing a cross-section of the volume data 800 is set (step S403). The two-dimensional coordinate system ck is designated by the volume data 800. For example, the two-dimensional system ck of a cross-section is formed with a coordinate origin o (Ox, Oy, Oz), an x-axis vector of the cross-section (Xx, Xy, Xz), and a y-axis vector of the cross-section (Yx, Yy, Yz) in the three-dimensional coordinate system C shown in FIG. 8.

As initial parameters, a cross-section width representing a length in a direction of the x-axis, a cross-sectional height representing a length in a direction of the y-axis, and a pixel interval on the cross-section can also be set. Such settings may be performed in advance by the CPU 301 shown in FIG. 3 or by a user inputting the parameters.

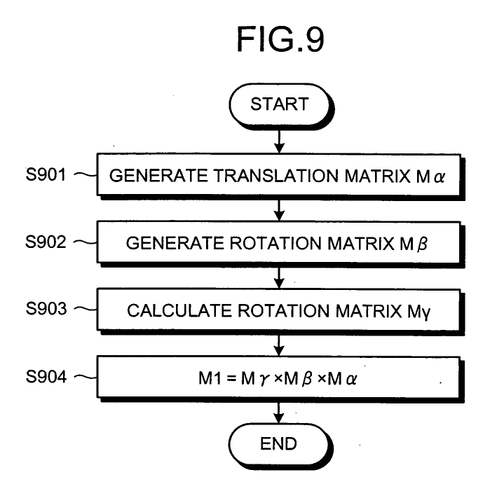

Then, as shown in FIG. 4, a coordinate-system transformation matrix for transforming the two-dimensional coordinate system ck to the three-dimensional coordinate system C is calculated (step S404). FIG. 9 is a flowchart of a process for calculating a coordinate-system transformation matrix at step S404. As shown in FIG. 9, a matrix Ma is first generated for translating the origin (0, 0) of the two-dimensional coordinate system ck to the coordinate values o(Ox, Oy, Oz) in the three-dimensional coordinate system C (step S901). The matrix Mα is expressed as

$${M}_{α} = ( \begin{matrix}1 & 0 & 0 & {O}_{x} \\ 0 & 1 & 0 & {O}_{y} \\ 0 & 0 & 1 & {O}_{z} \\ 0 & 0 & 0 & 1\end{matrix} ) \qquad ( 1 )$$

Next, a matrix Mβ for rotating an x-axis vector (1, 0) in the two-dimensional coordinate system ck to the x-axis vector x(Xx, Xy, Xz) in the three-dimensional coordinate system C (step S902). An outer-product vector of an X-axis vector X and the x-axis vector x serves as a rotation axis. Moreover, an angle θ formed by the X-axis vector X and the x-axis vector x serves as a rotation angle. From a magnitude of the outer-product vector, sin θ is calculated. From an inner product of the X-axis vector X and the x-axis vector x, cos θ is calculated. Then, based on the outer-product vector, sin θ, and cos θ, the matrix Mβ is calculated. The calculated matrix Mβ is expressed as

$${M}_{β} = ( \begin{matrix}{x}_{x} & - {x}_{x} & - {x}_{x} & 0 \\ {x}_{y} & \begin{matrix}( {x}_{z} {x}_{z} + {x}_{x} {x}_{y} {x}_{y} ) / \\ ( {x}_{y} {x}_{y} + {x}_{z} {x}_{z} )\end{matrix} & \begin{matrix}( {x}_{x} {x}_{y} {x}_{z} - {x}_{y} {x}_{z} ) / \\ ( {x}_{y} {x}_{y} + {x}_{z} {x}_{z} )\end{matrix} & 0 \\ {x}_{z} & \begin{matrix}( {x}_{x} {x}_{y} {x}_{z} - {x}_{y} {x}_{z} ) / \\ ( {x}_{y} {x}_{y} + {x}_{z} {x}_{z} )\end{matrix} & \begin{matrix}( {x}_{y} {x}_{y} + {x}_{x} {x}_{z} {x}_{z} ) / \\ ( {x}_{y} {x}_{y} + {x}_{z} {x}_{z} )\end{matrix} & 0 \\ 0 & 0 & 0 & 1\end{matrix} ) \qquad ( 2 )$$

Then, a matrix Mγ is calculated for rotating a Y′ vector, which is obtained through rotational transformation of a y-axis vector (0, 1) in the two-dimensional coordinate system ck with the matrix Mβ, to the y-axis vector y(Yx, Yy, Yz) in the three-dimensional coordinate system C (step S903). Specifically, the Y′-axis vector is calculated by Eq. 3.
Y′=Mβ×Y (3)

Similarly to the case of step S902, an outer-product vector of the Y′-axis vector and the y-axis vector serves as a rotation axis. Also, an angle φ formed by the Y′-axis vector and the y-axis vector servers as a rotation angle. From a magnitude of the outer-product vector, sin φ is calculated. From an inner product of the Y′-axis vector and the y-axis vector, cos φ is calculated. Then, based on the outer-product vector, sin φ, and cos φ, a matrix Mγ is calculated.

Based on the matrices Mα, Mβ, and Mγ obtained at steps S901 to S903, a transformation matrix M1 is calculated by Eq. 4 (step S904).
M1=Mγ×Mβ×Mα (4)

Then, as shown in FIG. 4, i=1 is set (step S405). As shown in FIG. 8, for a pixel Gi of a cross-section positioned at coordinates pki(xki, yki) in the two-dimensional coordinate system ck, three-dimensional positional coordinates Pi(Xi, Yi, Zi) in the three-dimensional coordinate system C are calculated (step S406). Specifically, since the coordinates pki(xki, yki) of the pixel Gi correspond to the three-dimensional positional coordinates Pi(Xi, Yi, Zi), three-dimensional positional coordinates Pi(Xi, Yi, Zi) are calculated based on the transformation matrix M1 generated at step S404 with Eq. 5.
Pi=M1×pki (5)

Thus, a pixel value Qi(Pi) of the three-dimensional positional coordinates Pi(Xi, Yi, Zi) associated with the pixel Gi is set as a pixel value qki(pki) of the pixel Gi in the two-dimensional coordinate system ck (step S407). More specifically, a complementing process is performed using eight peripheral pixel values of the three-dimensional positional coordinates Pi(Xi, Yi, Zi). Thus, pixel values of the cross-sectional image can be obtained from the pixel values of the volume data 800.

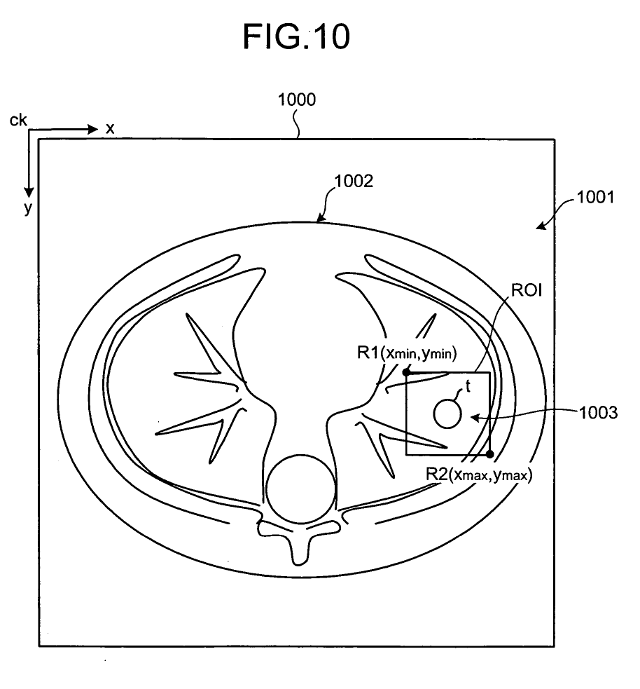

If i=n is not satisfied (“NO” at step S408), not all pixel values of the cross-section have yet been determined. Therefore, a process returns to step S406. On the other hand, if i=n (“YES” at step S408), a cross-sectional image in the two-dimensional coordinate system ck is displayed (step S409). FIG. 10 is a schematic of a tomographic image displayed on a display screen. As shown in FIG. 10, a display screen 1000 includes a display area 1001 in which a cross-sectional image 1002 is displayed. In a cross-sectional image 1003 in a region of interest ROI in the display area 1001, a cross-sectional image t of a tumor is shown.

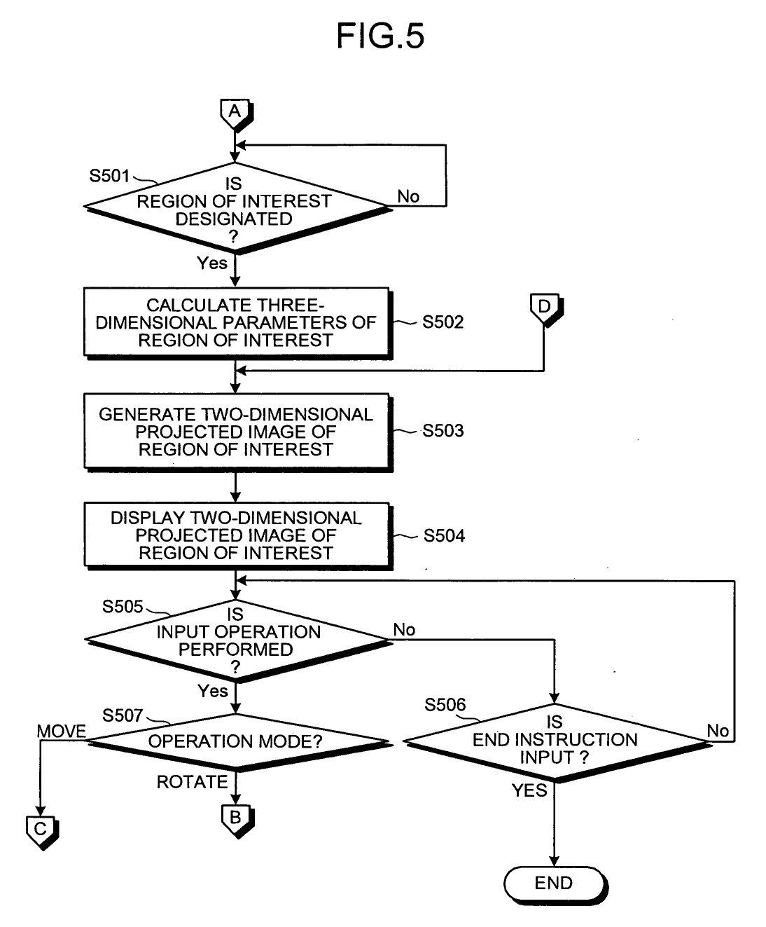

Then, as shown in FIG. 5, from the cross-sectional image 1002, the region of interest ROI is arbitrarily designated (step S501). Designation of the region of interest ROI is performed by the user using an input device, such as the mouse 311 and the keyboard 310 shown in FIG. 3 or others including a pen tablet. For example, as shown in FIG. 10, a point R1(xmin, ymin) and a point R2(xmax, ymax) to be diagonal points of the region of interest ROI are designated. The region of interest ROI may be designated with a center point to be a center of the region of interest ROI and an end point serving as a boundary of the region of interest ROI.

Next, three-dimensional parameters of the region of interest ROI designated at step S501 are calculated (step S502). The three-dimensional parameters include center coordinates (ROIx, ROIy) of the region of interest ROI and three-dimensional sizes ROIw, ROIh, and ROId of the region of interest ROI. For the region of interest ROI shown in FIG. 10, the center coordinates (ROIx, ROIy) can be calculated by Eq. 6.
(ROIx, ROIy)=[(xmax)+(xmin)/2, (ymax+ymin)/2] (6)

The three-dimensional size ROIw represents a length in the direction of the x-axis of the region of interest ROI, and can be calculated by Eq. 7. The three-dimensional size ROIh represents a length in the direction of the y-axis of the region of interest ROI, and can be calculated by Eq. 8.
ROIw=xmax−ymin (7)
ROIh=ymax−ymin (8)

Since the region of interest ROI is three-dimensionally displayed, the three-dimensional size ROId, which is a parameter representing a depth (direction of a z-axis) on an x-y plane, is required to be calculated. The three-dimensional size ROId can be approximated by Eq. 9.
ROId=max(ROIw, ROIh) (9)

The region of interest ROI is a region for which the user sees a tissue inside an organ, for example, a tumor or a polyp. Since a tumor or a polyp is substantially spherical, the shape can be approximated by Eq. 9. The three-dimensional size ROId may be calculated by min(ROIw, ROIh) instead of max (ROIw, ROIh). An average value of ROIw and ROIh may be used as the three-dimensional size ROId.

Then, a two-dimensional projected image that three-dimensionally represents a portion inside the region of interest ROI is generated (step S503). For example, the volume data 800 corresponding to the cross-sectional image 1003 is subjected to volume rendering display. Specifically, a two-dimensional projected image VR(x, y) at two-dimensional coordinates (x, y) of the region of interest ROI is calculated by Eq. 10.

$$VR ( x , y ) = {\sum }_{z = 0}^{ROld} C ( x , y , z ) \times T ( x , y , z ) \times E ( x , y , z ) \qquad ( 10 )$$

In Eq. 10, C(x, y, z) is a diffusion value representing shadow, T(x, y, z) is a density function representing opacity, and E(x, y, z) is an amount of light representing attenuation of light. Then, the two-dimensional projected image generated is displayed on the display screen 1000 (step S504). Specifically, using Eq. 11, an overlaying process is performed in which the two-dimensional projected image VR(x, y) is overlaid on a tomographic image.
p(x, y)=VR(x-xₘᵢₙ, y-yₘᵢₙ)

where xₘᵢₙ<x<xₘₐₓ, and yₘᵢₙ<y<yₘₐₓ
p(x, y)=p(x, y) etc. (11)

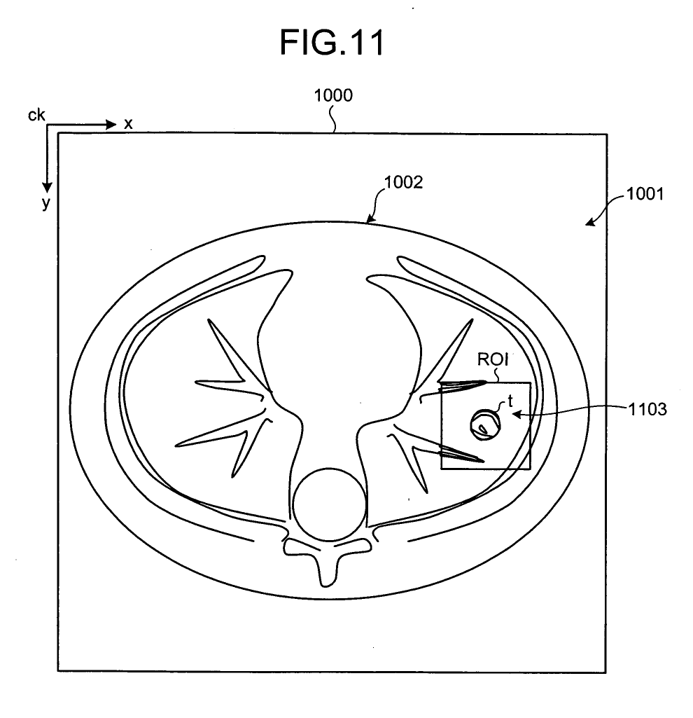

Thus, the two-dimensional projected image VR(x, y) can be displayed at two-dimensional positional coordinates p(x, y) in the region of interest ROI on the cross-sectional image. FIG. 11 is a schematic of a cross-sectional image that includes a two-dimensional projected image displayed in a region of interest. In the region of interest ROI, a two-dimensional projected image 1103, which three-dimensionally represents the cross-sectional image 1003 shown in FIG. 10, is displayed. The two-dimensional projected image 1103 is obtained using Eq. 10.

Specifically, in the region of interest ROI, a two-dimensional projected image T is displayed. The two-dimensional projected image T three-dimensionally represents the image t of a tumor shown in FIG. 10 is displayed. Thus, an image representing even a depth of a region for which the user desires to locally view (the region of interest ROI) or a three-dimensional image positioned on a cross-section can be viewed. As a result, a lesion can be identified with ease compared to a case of a cross-sectional image.

If no input operation is performed by the user (“NO” at step S505), and an end instruction is input (“YES” at step S506), the process ends. If the end instruction is not input (“NO” at step S506), the process returns to step S505, and a display of the two-dimensional projected image is maintained.

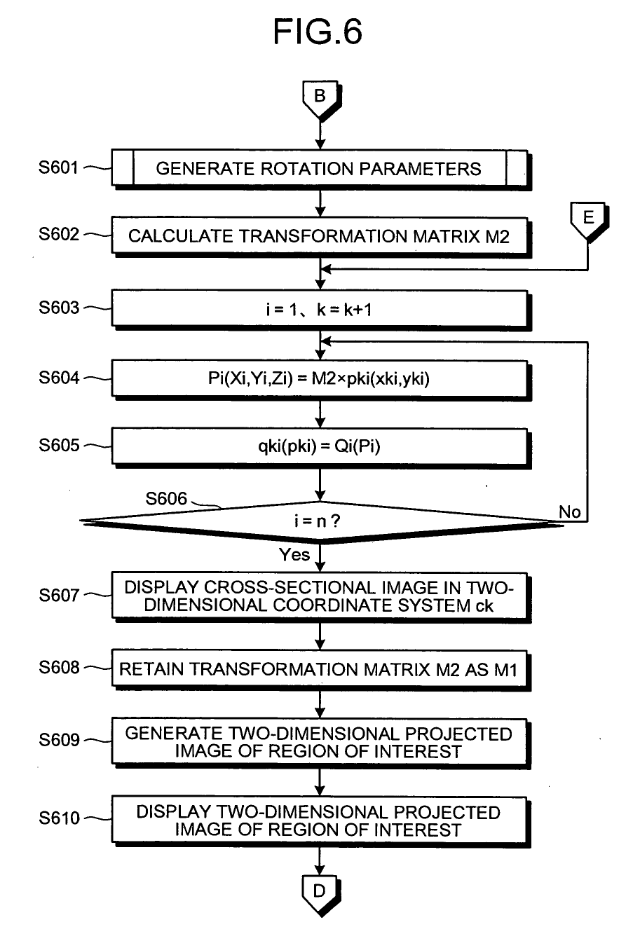

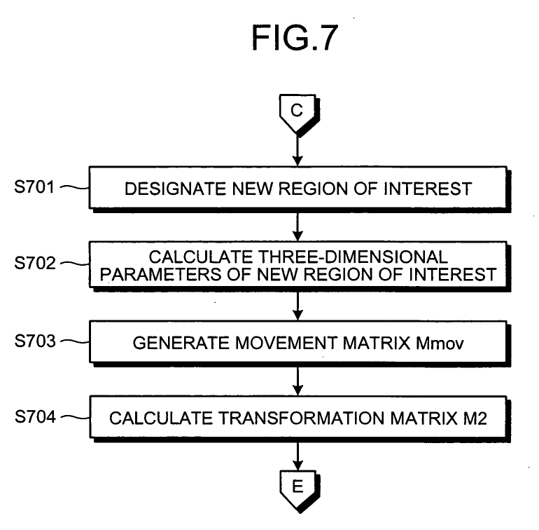

On the other hand, if an input operation is performed by the user (“YES” at step S505), an operation mode is determined (step S507). If the operation mode is “rotate” (“ROTATE” at step S507), the process proceeds to step S601 shown in FIG. 6. On the other hand, if the operation mode is “move” (“MOVE” at step S507), the process proceeds to step S701 shown in FIG. 7.

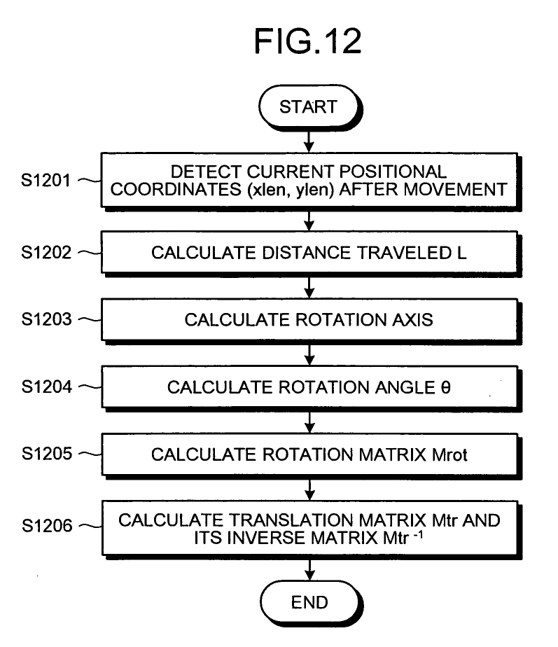

When the operation mode is “rotate” (“ROTATE” at step S507), rotation parameters are generated (step S601) as shown in FIG. 6. FIG. 12 is a flowchart of a process for generating the rotation parameters. A case in which the mouse 311 is used as an input device is explained.

As shown in FIG. 12, while taking a point at the positional coordinates of the cursor on the display screen 1000 as an origin of movement, current positional coordinates of a cursor shifted by moving the mouse 311 are first detected in the case where (step S1201). Based on the current positional coordinates (xlen, ylen) detected, a distance L traveled by the mouse 311 is then calculated by the Eq. 12 (step S1202).
L=\sqrt{xlen²+ylen²} (12)

Then, a rotation-axis vector V(ylen/L, xlen/L, 0) serving as a rotation axis is calculated (step S1203). A rotation angle Θ is then calculated (step S1204). The rotation angle Θ is calculated by Eq. 13.
Θ=K×L (13)

K is a proportionality factor for making the rotation angle Θ proportional to the distance L. Based on the rotation-axis vector V and the rotation angle Θ, a rotation matrix Mrot serving as a rotation parameter is calculated (step S1205). When it is assumed that Vx=ylen/L and Vy=xlen/L, the rotation matrix Mrot is expressed by Eq. 14.

$${M}_{rot} = ( \begin{matrix}\begin{matrix}{V}_{x} \cdot {V}_{x} \cdot \\ ( 1 - cos Θ ) + cos Θ\end{matrix} & \begin{matrix}{V}_{x} \cdot {V}_{y} \cdot \\ ( 1 - cos Θ )\end{matrix} & - {V}_{y} \cdot sin Θ & 0 \\ \begin{matrix}{V}_{y} \cdot {V}_{x} \cdot \\ ( 1 - cos Θ )\end{matrix} & \begin{matrix}{V}_{y} \cdot {V}_{y} \cdot \\ ( 1 - cos Θ ) + cos Θ\end{matrix} & {V}_{x} \cdot sin Θ & 0 \\ {V}_{y} \cdot sin Θ & - {V}_{x} \cdot sin Θ & cos Θ & 0 \\ 0 & 0 & 0 & 1\end{matrix} ) \qquad ( 14 )$$

Next, a translation matrix Mtr and an inverse matrix Mtr⁻¹ of the translation matrix Mtr being rotation parameters are calculated (step S1206). With the translation matrix Mtr and inverse matrix Mtr⁻¹, a rotation center can be moved to the point at the center coordinates of the region of interest ROI. The translation matrix Mtr and inverse matrix Mtr⁻¹ are expressed as Eq. 15 and Eq. 16 respectively.

$$\begin{matrix}Mtr = ( \begin{matrix}1 & 0 & 0 & {ROI}_{x} \\ 0 & 1 & 0 & {ROI}_{y} \\ 0 & 0 & 1 & 0 \\ 0 & 0 & 0 & 1\end{matrix} ) & ( 15 ) \\ {Mtr}^{- 1} = ( \begin{matrix}1 & 0 & 0 & - {ROI}_{x} \\ 0 & 1 & 0 & - {ROI}_{y} \\ 0 & 0 & 1 & 0 \\ 0 & 0 & 0 & 1\end{matrix} ) & ( 16 )\end{matrix}$$

In Eq. 15, coordinates (ROIx, ROIy) represent center coordinates of the region of interest ROI in the two-dimensional coordinate system ck of the cross-sectional image, and is calculated by Eq. 17.

$$( \begin{matrix}{ROI}_{x} \\ {ROI}_{y} \\ NoUse \\ NoUse\end{matrix} ) = {M}_{1}^{- 1} \times ( \begin{matrix}{ROI}_{x} \\ {ROI}_{y} \\ {ROI}_{z} \\ 1\end{matrix} ) \qquad ( 17 )$$

In Eq. 17, coordinates (ROIx, ROIy, ROIz) represents center coordinates of the region of interest ROI in the three-dimensional coordinate system C. Based on the center coordinates, the rotation parameters of the rotation matrix Mrot, the translation matrix Mtr, and the inverse matrix Mtr⁻¹ are generated.

Next, a transformation matrix M2 is calculated (step S602). The transformation matrix M2 is a matrix obtained by updating the transformation matrix M1, and is calculated by the Eq. 18 using the rotation parameters of the rotation matrix Mrot, the translation matrix Mtr, and the inverse matrix Mtr⁻¹ thereof generated at step S1201.
M2=M1×Mtr×Mrot×Mtr⁻¹ (18)

It is assumed that i=1 and k=k+1 (step S603), and three-dimensional positional coordinates Pi(Xi, Yi, Zi) in the three-dimensional coordinate system C are calculated for the pixel on the cross-section positioned at the coordinates pki(xki, yki) in the two-dimensional coordinate system ck (step S604). Specifically, Since the three-dimensional positional coordinates Pi(Xi, Yi, Zi) correspond to the coordinates pki(xki, yki) in the two-dimensional coordinate system ck of the pixel on the section, the three-dimensional positional coordinates Pi(Xi, Yi, Zi) are calculated by Eq. 19 using the transformation matrix M2 generated at step S602.
Pi=M2×pki (19)

Then, a pixel value Qi(Pi) of the three-dimensional positional coordinates Pi(Xi, Yi, Zi) associated with the pixel on the cross-section is set as a pixel value qki(pki) of the pixel on the section in the two-dimensional coordinate system ck (step S605). More specifically, a complementing process is performed using eight peripheral pixel values of the three-dimensional positional coordinates Pi(Xi, Yi, Zi). Thus, pixel values of the cross-sectional image can be obtained from the pixel values of the volume data 800.

If i=n is not satisfied (“NO” at step S606), not all pixel values of the cross-section have yet been determined. Therefore, the process returns to step S604. On the other hand, if i=n (“YES” at step S606), a new cross-sectional image in the two-dimensional coordinate system ck is displayed (step S607).

Then, the transformation matrix M2 is retained as the transformation matrix M1 (step S608). Next, a new two-dimensional projected image of the region of interest ROI is generated (step S609), and then, a new two-dimensional projected image is displayed on the region of interest ROI on the cross-sectional image 1002 (step S610). The process proceeds to step S503 shown in FIG. 5. The processes at steps S609 and S610 are identical to those at steps S503 and S504 shown in FIG. 5, therefore, explanation is omitted.

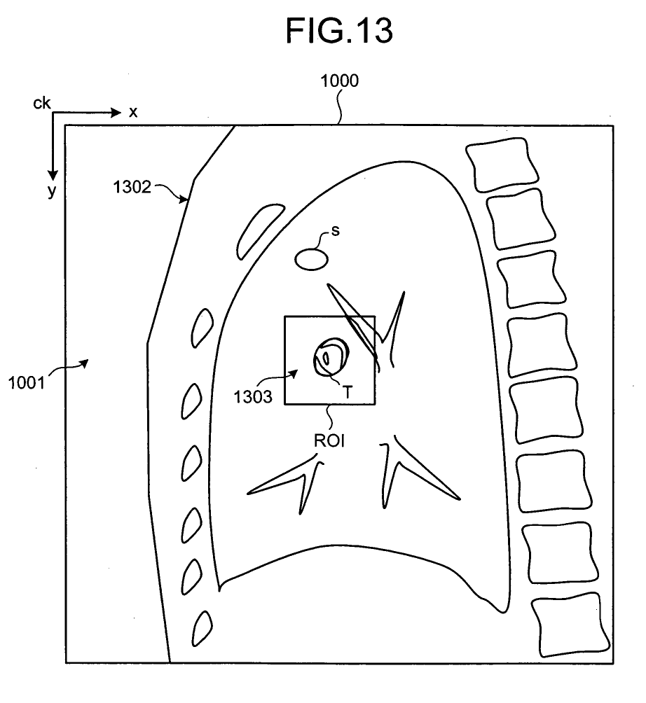

An image displayed by the processes at steps S609 and S610 is shown. FIG. 13 is a schematic of an image after a rotation process. By a coordinate transforming process using the transformation matrix M2, the two-dimensional projected image 1103 shown in FIG. 11 is rotated, and the two-dimensional projected image T of the tumor is also rotated. Furthermore, the display area 1001 outside the region of interest ROI is rotated according to the rotation of the region of interest ROI.

By such a rotating process, a cross-sectional image 1302 is obtained that is an image viewed from a direction identical to a direction in which the region of interest ROI is viewed. Therefore, it becomes possible to find a cross-sectional image s of another tissue (for example, a tumor) that could not be found in the cross-sectional image 1002 viewed from a different direction as shown in FIG. 11. Thus, the positional relation of a two-dimensional projected image 1303, which is currently viewed by the user, can be grasped from the cross-sectional image 1302 rotated. As a result, the state inside the living body H can be accurately diagnosed.

When the operation mode is “move” (“MOVE” at step S507), and when the region of interest ROI is moved to a different portion by operating the mouse 311, a region of interest ROI′, which is a new region of interest after movement, is designated as shown in FIG. 7 (step S701). Three-dimensional parameters are calculated for the region of interest ROI′ (step S702). The processes at steps S701 and S702 are identical to those at step S501 and S502 shown in FIG. 5, and explanation is omitted.

Then, a movement matrix Mmov is generated (step S703). The movement matrix Mmov is represented by Eq. 20, where the distances to the region of interest ROI′ in the directions of the x-axis and the y-axis in the two-dimensional coordinate system ck are Dx and Dy respectively.

$$Mmov = ( \begin{matrix}1 & 0 & 0 & {D}_{x} \\ 0 & 1 & 0 & {D}_{y} \\ 0 & 0 & 1 & 0 \\ 0 & 0 & 0 & 1\end{matrix} ) \qquad ( 20 )$$

Based on the movement matrix Mmov generated and the transformation matrix M1, a new transformation matrix M2 is calculated (step S704) by Eq. 21.
M2=Mmov×M1 (21)

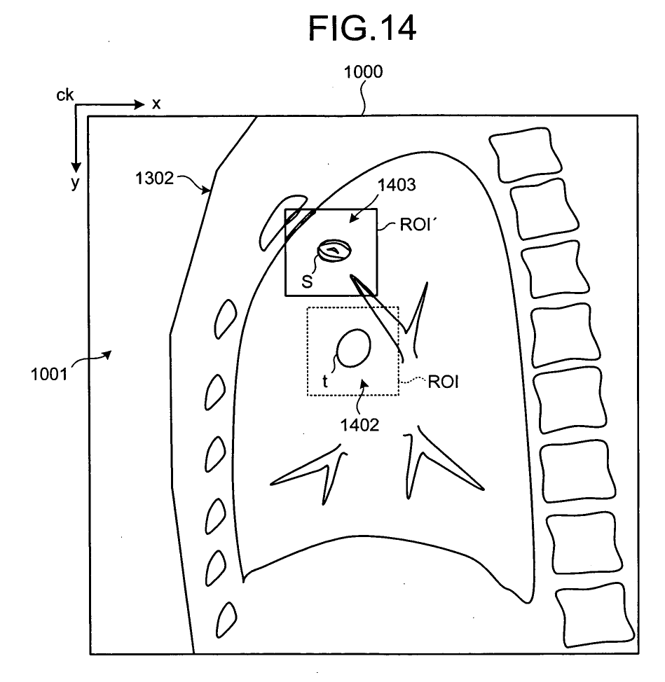

Then, the process proceeds to step S603 shown in FIG. 6 for performing the processes at steps S603 to S610 similarly to the rotating process. An image displayed as a result of the moving process is shown in FIG. 14.

As shown in FIG. 14, a position of the region of interest is moved from a position of the region of interest ROI shown in FIG. 13 to a position the region of interest ROI′ newly designated. In the region of interest ROI′, a two-dimensional projected image 1403 is displayed. As shown FIG. 14, in the region of interest ROI, in which the two-dimensional projected image 1303 (including the image T of the tumor) used be displayed before the moving process as shown in FIG. 13, a two-dimensional image (including the cross-sectional image t of the tumor) is displayed because a portion inside the region of interest ROI has become a portion outside the region of interest ROI′. On the other hand, a portion displayed with the cross-sectional image s shown in FIG. 13 is positioned inside of the region of interest ROI′, therefore, the portion is displayed with a two-dimensional projected image S.

Alternatively, although the portion that used to be displayed with the two-dimensional projected image 1303 in the region of interest ROI shown in FIG. 13 is outside the region of interest ROI′, the two-dimensional projected image 1303 may be maintained to be displayed. This is effective when an original region, the region of interest ROI, is to be reviewed or compared with the two-dimensional projected image 1403 in the region of interest ROI′.

Thus, according to the embodiment described above, when the two-dimensional projected image in the region of interest ROI is rotated, the rotation parameters are retained. Based on the rotation parameters retained, the two-dimensional image representing a cross-section outside the region of interest ROI is also rotated. Therefore, according to the rotation of the region of interest ROI, a tomographic image outside the region of interest ROI can be displayed so as to be viewed from an angle corresponding to a rotation angle of the two-dimensional projected image. Therefore, a positional relation between portions inside and outside the region of interest ROI can be appropriately grasped.

Moreover, when the moving process is performed after the rotating process, because the rotation parameters are retained, it is possible to display the two-dimensional projected image 1403 rotated at an identical angle to an angle at which the region of interest ROI is rotated.

Furthermore, if the present invention is applied to the series of tomographic images 200 of the living body H, the inside of the living body H is locally examined by designating the region of interest ROI. Therefore, by smoothly performing the rotating process or the moving process on the two-dimensional projected image 1103 in the region of interest ROI (or the two-dimensional projected image 1403 in the region of interest ROI′) sequentially, an efficient and accurate diagnosis can be carried out. Moreover, the state of the inside of the living body H can be accurately grasped, thereby making it possible to find even a lesion, such as a malignant tumor or a polyp, existing in a region in which the lesion would otherwise be difficult to be found.

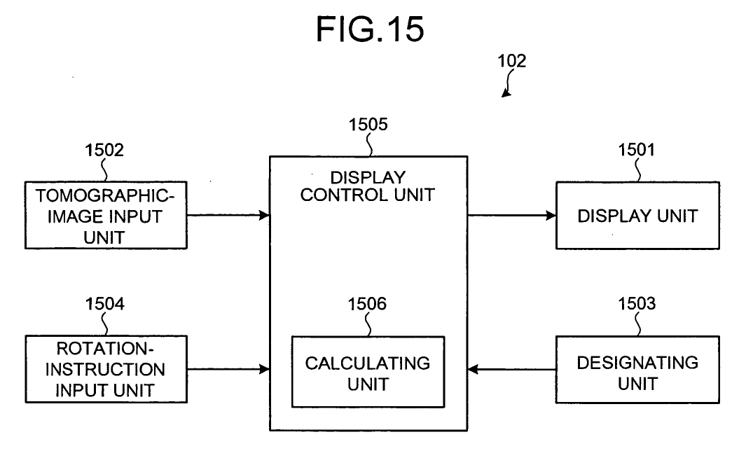

FIG. 15 is a block diagram of the image display apparatus 102. As shown in FIG. 15, the image display apparatus 102 includes a display unit 1501, a tomographic-image input unit 1502, a designating unit 1503, a rotation-instruction input unit 1504, and a display control unit 1505.

The display unit 1501 includes the display screen 1000 on which a cross-sectional image generated based on tomographic images is displayed. Specifically, on the display screen 1000, the series of tomographic images 200 (refer to FIG. 2) of the living body H obtained by the tomography scanner 101 shown in FIG. 1 or a cross-sectional image (refer to FIGS. 10, 11, 13, and 14) of an arbitrary section generated based on the tomographic images 200 is displayed. The display unit 1501 achieves its function by, for example, the display 308 shown in FIG. 3.

The tomographic-image input unit 1502 accepts input of the series of tomographic images 200 of the living body H obtained by the tomography scanner 101. Specifically, the tomographic-image input unit 1502 performs the process at step S401 shown in FIG. 4. The tomographic-image input unit 1502 achieves its function by, for example, the CPU 301 executing a program recorded on the ROM 302, the RAM 303, the HD 305, the FD 307, or the like shown in FIG. 3, or by the I/F 309.

The designating unit 1503 accepts a designation of an arbitrary region of interest in the display area of the cross-sectional image. Specifically, the designating unit 1503 performs the processes at step S501 shown in FIG. 5 and step S701 shown in FIG. 7. The designating unit 1503 achieves its function by, for example, the CPU 301 executing a program recorded on the ROM 302, the RAM 303, the HD 305, the FD 307, or the like shown in FIG. 3, or by the I/F 309.

The rotation-instruction input unit 1504 accepts an input of a rotation instruction for rotating the two-dimensional projected image displayed on the display screen 1000. Specifically, the rotation-instruction input unit 1504 performs the processes at steps S505 and S507 of FIG. 5 and step S601 of FIG. 6. The rotation-instruction input unit 1504 achieves its function by, for example, the CPU 301 executing a program recorded on the ROM 302, the RAM 303, the HD 305, the FD 307, or the like shown in FIG. 3, or by the I/F 309.

The display control unit 1505 controls the display screen 1000 to display a tomographic image. Specifically, the display control unit 1505 performs the processes at steps S402 to S409 of FIG. 4 to cause a tomographic image to be displayed on the display screen 1000. Moreover, the display control unit 1505 controls to display, in the region of interest ROI, a two-dimensional projected image that three-dimensionally represents a portion of the cross-sectional image inside the region of interest ROI. Specifically, the display control unit 1505 performs the processes at steps S502 to S504 shown in FIG. 5 to cause a two-dimensional projected image to be displayed on the region of interest ROI.

Furthermore, the display control unit 1505 controls to display the two-dimensional projected image based on the rotation instruction, and to display the cross-sectional image that corresponds to the two-dimensional projected image thus displayed in a display area outside the region of interest ROI. Specifically, the display control unit 1505 performs the processes at steps S602 to S610 shown in FIG. 6 to display the two-dimensional projected image based on the rotation parameters including parameters for a viewing angle, a rotation axis, and a rotation angle, obtained at step S601. In addition, by synchronizing with or according to the rotation instruction, the display control unit 1505 controls to display, outside the region of interest ROI, a cross-sectional image of a portion outside the region of interest ROI corresponding to rotation of the two-dimensional projected image.

Furthermore, upon acceptance of designation of the region of interest ROI′ different from the region of interest ROI, a two-dimensional projected image that three-dimensionally represents a portion of a cross-sectional image inside the region of interest ROI′ is displayed in the region of interest ROI′. In the region of interest ROI, a cross-sectional image of the portion inside the region of interest ROI may be displayed, or the two-dimensional projected image may be maintained to be displayed. This display controlling process is achieved by performing the processes at steps S701 to S704 shown in FIG. 7 and those at steps S603 to S610 shown in FIG. 6.

Furthermore, the display control unit 1505 includes a calculating unit 1506 that performs various arithmetic operation processes. For example, based on two-dimensional coordinates representing the region of interest ROI (or region of interest ROI′), the calculating unit 1506 calculates depth information representing a depth of the region of interest ROI (or region of interest ROI′). Based on the depth information, a two-dimensional projected image is displayed. Specifically, the process at step S502 shown in FIG. 5 (for the region of interest ROI′, step S702 shown in FIG. 7) is performed.

The display control unit 1505 achieves its function by, for example, the CPU 301 executing a program recorded on the ROM 302, the RAM 303, the HD 305, the FD 307, or the like shown in FIG. 3.

Thus, it becomes possible to instantaneously recognize that the two-dimensional projected image displayed is an image three-dimensionally representing a tomographic image in the region of interest ROI. Furthermore, a cross-sectional image of a portion outside the region of interest ROI can be displayed corresponding to rotation made for the two-dimensional projected image. Thus, it becomes possible to instantaneously grasp a positional relation between the two-dimensional projected image and the cross-sectional image outside the region of interest ROI.

Moreover, the region of interest ROI can be moved by designating another region of interest ROI′. When a display area outside the region of interest ROI is desired to be locally viewed, a two-dimensional projected image in the other region of interest ROI′ can be displayed. Furthermore, in the original region of interest ROI, a cross-sectional image can be displayed instead of the two-dimensional projected image, thereby improving efficiency in arithmetic operation. Moreover, the two-dimensional projected image can be maintained to be displayed in the original region of interest. Thus, when the user desires to review the two-dimensional projected image in the original region of interest ROI, the user can view the two-dimensional projected image without performing redundant operation of re-designating the region of interest ROI.

Furthermore, a three-dimensional space represented by a two-dimensional projected image can be approximated to a cube from two two-dimensional sizes (ROIw, ROIh) of the region of interest ROI. Therefore, in the case of a tomographic image of the living body H, a two-dimensional projected image suitable for displaying a spherical tissue, such as a tumor or a polyp, can be generated.

As described above, with the image display apparatus and the computer product according to the embodiment of the present invention, it is possible for the user to easily and instantaneously recognize positional relation between a two-dimensional projected image of a portion for which the user desires to locally view and a cross-sectional image around the portion. Moreover, it is possible to three-dimensionally display a local portion. Therefore, an organ or tissue inside the living body H can be viewed at various angles, thereby enabling to easily grasp a morphological feature of a lesion. As a result, accuracy in diagnosis can be improved. Particularly, it is possible to easily find a lesion, such as a malignant tumor or a polyp, existing in a region in which the lesion would otherwise be difficult to be found, thereby enabling to find a lesion or the like at an early stage.

An image displaying method described in the present embodiment can be achieved by a computer, such as a personal computer and a work station, executing a computer program provided in advance. The computer program is recorded on a computer-readable recording medium, such as an HD, an FD, a CD-ROM, a MO disk, and a DVD, and is executed by being read from the recording medium by a computer. Also, the computer program may be a transfer medium that can be distributed via a network, such as the Internet.

According to the present invention, it is possible for the user to easily and intuitively recognize positional relation between a portion in a two-dimensional projected image and a portion around the two-dimensional projected image. Moreover, it is possible to improve accuracy of diagnosis of a lesion.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image display apparatus comprising:
a display unit that includes a display screen on which
a cross-sectional image generated based on a plurality of tomographic images is displayed;
a designating unit that designates a first region in the cross-sectional image, the first region being an arbitrary region of interest; and
a control unit that controls to display, in the-first region, a two-dimensional projected image that three-dimensionally expresses a portion of the cross-sectional image inside the first region.

2. The image display apparatus according to claim 1, further comprising a rotation-instruction input unit that inputs a rotation instruction for rotating the two-dimensional projected image, wherein
the control unit controls to display the two-dimensional projected image in a sate based on the rotation instruction, and to display a cross-sectional image of a portion outside the first region, corresponding to the state of the two-dimensional projected image displayed based on the rotation instruction.

3. The image display apparatus according to claim 1, wherein
the designating unit designates a second region that is a different region of interest from the first region, and
the control unit controls to display, in the second region, a two-dimensional projected image that three-dimensionally expresses a portion of a cross-sectional image positioned inside the second region.

4. The image display apparatus according to claim 3, wherein
the control unit controls to display, in the first region, a cross-sectional image of the portion inside the first region.

5. The image display apparatus according to claim 3, wherein
while the two-dimensional projected image of the portion inside the second region is displayed in the second region, the control unit controls to display, in the first region, the two-dimensional projected image of the portion inside the first region.

6. The image display apparatus according to claim 1, wherein
the control unit includes a calculating unit that calculates depth information representing a depth of the first region based on two-dimensional coordinates of the first region, and controls to display the two-dimensional projected image based on the depth information.

7. A computer-readable recording medium that stores an image display program for displaying a cross-sectional image generated based on a plurality of tomographic images on a display screen, the image display program making a computer execute:
designating a first region in the cross-sectional image, the first region being an arbitrary region of interest; and
displaying, in the first region, a two-dimensional projected image that three-dimensionally expresses a portion of the cross-sectional image inside the first region.

8. The computer-readable recording medium according to claim 7, wherein
the image display program further makes the computer execute inputting a rotation instruction for rotating the two-dimensional projected image,
displaying the two-dimensional projected image in a sate based on the rotation instruction, and
displaying a cross-sectional image of a portion outside the first region, corresponding to the state of the two-dimensional projected image displayed based on the rotation instruction.

9. An image display method for displaying a cross-sectional image generated based on a plurality of tomographic images on a display screen, the image display method comprising:
designating a first region in the cross-sectional image, the first region being an arbitrary region of interest; and
displaying, in the first region, a two-dimensional projected image that three-dimensionally expresses a portion of the cross-sectional image inside the first region.

10. The image display method according to claim 9, further comprising:
inputting a rotation instruction for rotating the two-dimensional projected image;
displaying the two-dimensional projected image in a sate based on the rotation instruction; and
displaying a cross-sectional image of a portion outside the first region, corresponding to the state of the two-dimensional projected image displayed based on the rotation instruction.
